(19) United States
(12) Patent Application Publication
(10) Pub. No.: US 2015/0288227 A1
(43) Pub. Date: Oct. 8, 2015

(54) Opposing Fields Generator

(71) Applicant: Garrett Stewart Sayre, Newport News, VA (US)

(72) Inventor: Garrett Stewart Sayre, Newport News, VA (US)

(21) Appl. No.: 14/574,372

(22) Filed: Dec. 17, 2014

Related U.S. Application Data
(60) Provisional application No. 61/920,464, filed on Dec. 23, 2013.

(51) Int. Cl. H02K 1/06; H02K 7/18

(52) U.S. Cl. CPC H02K 1/06; H02K 7/1807; Y10S 74/09; H02K 53/00

(57) ABSTRACT

The Opposing Fields Generator is an energy producing device using opposing magnetic fields to produce energy through the implementation of any combination of strategic gearing, displacement, and shielding technologies to allow movement. This invention overcomes the problem of fixed magnetic fields interfering with one another at the point where a moving armature or other motion device cannot continue its movement by displacing one or more of the magnets' magnetic fields in order to redirect the magnetic energy to allow the rotor or other moving part to pass by and continue to make repeated rotations (or other movements) without the need to use any exterior energy sources.

### CROSS-REFERENCE TO RELATED APPLICATIONS

This patent application lays claim to the benefit of provisional patent application No. 61/920,464

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This is a nonprovisional utility patent for the purpose of providing energy and/or locomotion by means of opposing magnetic fields in permanent or semi-permanent magnets. This invention overcomes the problem of the opposing fields interfering with the complete and continuous rotation (or other movement) of such a device by displacing magnetic fields by various means.

### BRIEF SUMMARY OF THE INVENTION

The Opposing Fields Generator is an energy producing device using opposing magnetic fields to produce energy. This invention overcomes the problem of fixed magnetic fields interfering with one another in a motion-field. This invention overcomes any impassable point in the rotation (or other motion) of an armature (or other motion device) by incorporating a synchronized piston (or pistons or other sliding/moving device or devices) that retreats into a cylinder or other type of chamber (cylindrical or otherwise) to avoid magnetic forces that would otherwise oppose the continuous movement of (or related to) the primary rotational/moving device.

This patent also incorporates devices and materials that redirect the invention's magnetic field(s) to the benefit of the device's continued motion in order to increase its production of energy. This patent also incorporates devices and materials that affect the invention's magnetic fields to either minimize or maximize the magnets' magnetic strength through the strategic placement of any element that would affect the intensity of the magnetic field—such as the employment of different colored lights on plastic magnets to cause varying magnetic strengths in order to facilitate the movement of the generator's rotor, rotors, or other moving parts that allow motion to produce energy or movement.

### BRIEF DESCRIPTION OF THE SEVERAL VIEWS OF THE DRAWINGS

FIG. 1 is a side view of one section of the Opposing Fields Generator.

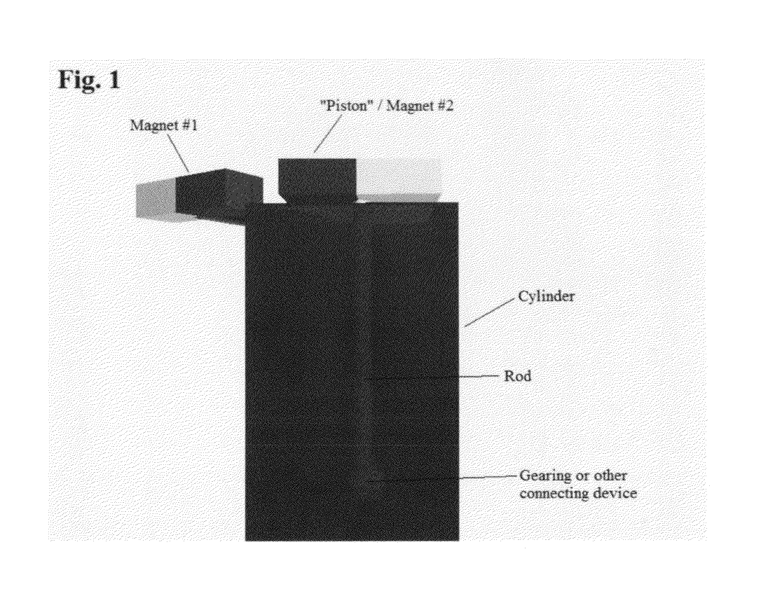

FIG. 2 is an overhead view of the Opposing Fields Generator. Both FIGS. 1 and 2 show one of many configurations that could be used to obtain continuous motion using permanent magnets to generate energy as described in the claims and descriptions herein. As Magnet #1 passes by Magnet #2 (see FIG. 2), Magnet #2 retreats into a cylinder via a synchronized “piston” (see FIG. 1) linked to Magnet #1 so that during the optimal time Magnet #2 will extend into the optimal position to push Magnet #1 via the two magnets' opposing and/or attracting fields. Magnet #2 would also retreat into the cylinder (which could be impregnated or otherwise endowed with antimagnetic shielding) in order to avoid conflicting polarities and at the same time generate energy in combination with Magnet #1. The above configuration could be accomplished with many different arrangements of the same basic principle with singular or multiple magnets positioned in various different positions and moving in various trajectories (such as rotational, cylindrical, spiral, etc.). Additionally, the cylinder could be of any shape or workable dimension as could any of the devices described in the claims and descriptions herein. FIGS. 1 and 2 are not meant to limit the claims. The figures are only meant to depict the basic principal behind the Claims.

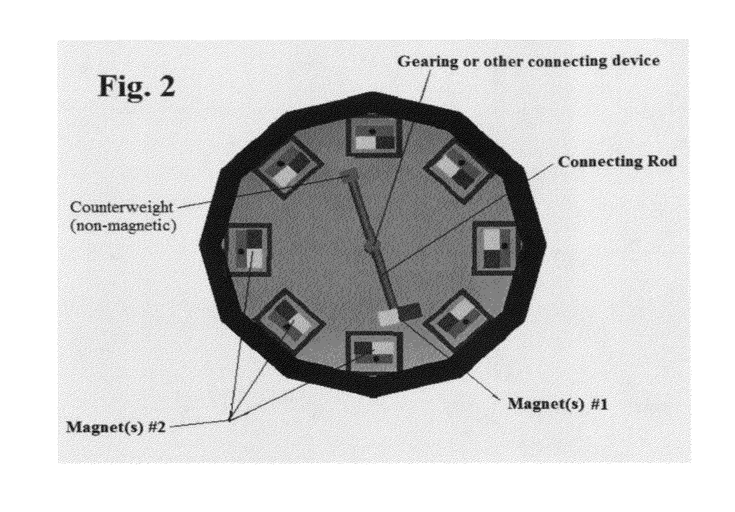

### DETAILED DESCRIPTION OF THE INVENTION

The Opposing Fields Generator is an energy producing device using opposing magnetic fields to produce energy. This invention overcomes the problem of fixed magnetic fields interfering with one another in a motion-field by incorporating a synchronized piston (or pistons or other sliding/moving device or devices) that retreat into a cylinder or other type of chamber (cylindrical or otherwise) to avoid opposing magnetic forces from (or related to) the primary rotational/moving device—and to also benefit from the magnetic forces that cause the motion to continue.

The Opposing Fields Generator is designed to use magnetic force to produce energy by using a system of directing and redirecting magnetic energy. This application is based on the concept of using a synchronized piston, gear, or other motion device (moving in a rotational, cylindrical, spiral or any other motion trajectory) that is connected to a permanent or semi-permanent magnet(s) that is moved by these motion devices in order to propel another permanent or semi-permanent magnet(s) on a rotating (or sliding) device (or devices), which energy is brought into the field of motion at the correct time to propel the motion of the rotating (or sliding) device—and removed from the magnetic field of energy at the correct time in order to allow the rotating or sliding device to pass by unimpeded while also benefiting from the device's magnetic fields that work to increase motion and, thereby, energy and/or locomotion.

The above arrangement thereby creates a method that utilizes the unique properties of a magnetic field while overcoming the conflict of two opposing magnetic fields, which is overcome by a synchronized motion and/or shielding and/or magnetic intensity modulating device removing the conflicting energy from the field of influence in order to create continuous movement by means of the innate magnetic fields of permanent or semi-permanent magnetic substances.

Therefore, the Opposing Fields Generator is an energy producing device using magnetic force in a way that allows continuous movement to produce energy using one or more magnets attached to a device which moves the magnet(s) to maximize the free flow of the movement created by the magnetic fields. One form of which could be magnets in a circle integrated with a piston or sliding device with a spinning magnet on a shaft in the center. This device could incorporate piston(s) [or other sliding device(s)] that retreat into a cylinder to avoid opposing forces from, or related to, the primary rotational device—and which emerges to allow the rotational device to be once again propelled into continued motion.

This patent also incorporates devices and materials that redirect or otherwise affect magnetic fields to either minimize or maximize magnetic energy through the strategic placement of any form of antimagnetic shielding or any element that would affect the direction or intensity of the magnetic field—such as the employment of different colored lights onto plastic magnets to cause varying magnetic strengths in order to facilitate the movement of the generator's rotor, rotors, or other moving parts that allow motion to produce energy or movement (which would facilitate the movement of the generator's rotor, rotors, or other moving parts in a way that would redirect the magnetic fields to produce motion and energy).

The above described antimagnetic shielding or magnetic intensity shifting materials would assist in overcoming conflicting fields of magnetic energy that would otherwise interfere with the energy-producing movement of the Opposing Fields Generator and enhance the action of magnetic fields that would otherwise not be present.

The Opposing Fields Generator could also employ the integration of a traditional motor that feeds off the energy being produced by the Opposing Fields Generator in a way where the traditional motor overcomes the resistance of a magnetic field (at some point in the Opposing Fields Generator's movement) in order to allow the continuing movement and production of energy that would exceed the amount of energy spent to overcome the opposing force. The device described above might also incorporate any pre-existing braking device. The device described above might also incorporate a pre-existing generating device. The device described above might also incorporate a locomotive device concurrently or independently.

1. Magnets arranged in such a way that the arrangement allows continuous movement by means of redirecting the magnetic fields by causing the magnets to be moved by a synchronized device that allows the movement to overcome any opposing magnetic fields that may inhibit motion.

2. The device in claim 1 in which a magnetic shielding device is integrated in order to assist in overcoming any opposing magnetic fields that may inhibit motion and in order to promote additional motion through the redirection of magnetic fields.

3. The device described in claim 1 that incorporates a piston in order to assist in overcoming any opposing magnetic fields that may inhibit motion and in order to promote additional motion through the redirection of magnetic fields.

4. The device described in claim 1 that incorporates any form of moving device in order to assist in overcoming any opposing magnetic fields that may inhibit motion and in order to promote additional motion through the redirection of magnetic fields.

5. The device described in claim 1 that incorporates materials that redirect magnetic fields in order to assist in overcoming any opposing magnetic fields that may inhibit motion and in order to promote additional motion through the redirection of magnetic fields.

6. The device described in claim 1 that incorporates materials that increase or decrease the strength of magnetic fields in order to allow the generator's movement to continue by overcoming an opposing magnetic field (for example, the use of different colored lights to minimize or maximize the production of energy in plastic magnets).

7. The device described in claim 1 that incorporates any pre-existing braking device.

8. The device described in claim 1 that incorporates any pre-existing generating device.

9. The device described in claim 1 that incorporates any locomotive device.

10. The device described in claim 1 that incorporates any number of pistons or other displacement devices described in claims 1-9.

11. The device described in claim 1 that incorporates any combination of the devices described in claims 1-10.
